(19) United States
(12) Patent Application Publication
(10) Pub. No.: US 2025/0149814 A1
(43) Pub. Date: May 8, 2025

(54) PLUG CONNECTOR AND CONNECTOR ASSEMBLY

(71) Applicant: HIROSE ELECTRIC CO., LTD., Kanagawa (JP)

(72) Inventors: Kouhei ODA, Kanagawa (JP); Junho KIM, Kanagawa (JP); Ryuhei KAGAMI, Kanagawa (JP); Shohei HOSODA, Kanagawa (JP)

(21) Appl. No.: 18/922,640

(22) Filed: Oct. 22, 2024

(30) Foreign Application Priority Data
Nov. 6, 2023 (JP) 2023-189401

(51) Int. Cl. H01R 12/73; H01R 12/57; H01R 13/405; H01R 13/504

(52) U.S. Cl. CPC H01R 12/732; H01R 12/57; H01R 13/405; H01R 13/504

(57) ABSTRACT

Provided is a plug connector mounted on a board, including: a housing, a plurality of terminals, and a pair of metal fittings, the housing has a pair of side wall portions, a pair of coupling wall portions, and a bottom wall portion; the pair of metal fittings is held at both ends of the housing in a longitudinal direction of the plug connector; the metal fitting has a pair of mount portions, a pair of curved portions, an outer portion, and a pair of coupling portions; the mount portion is provided on the bottom side of the housing; the curved portion is curved so as to cover part of an upper surface of the side wall portion; the outer portion covers an upper surface and an outer wall of the coupling wall portion; and the coupling portion couples the outer portion to the mount portion and the curved portion.

### CROSS-REFERENCE TO RELATED APPLICATION

This application claims priority from Japanese Patent Application No. 2023-filed with the Japan Patent Office on Nov. 6, 2023, the entire content of which is hereby incorporated by reference.

### BACKGROUND

### 1. Technical Field

The present disclosure relates to a plug connector and a connector assembly.

### 2. Related Art

A board-to-board electric connector has been known as a connector that connects surfaces of boards to each other. The board-to-board electric connector includes a pair of a plug connector and a receptacle connector, and the plug connector is inserted into the receptacle connector and these connectors are electrically connected to each other upon contact of contacts (conductive terminals) thereof. As a technique related to such a board-to-board electric connector, techniques described in, e.g., JP-A-2022-159066 and JP-A-2022-159067 have been known.

### SUMMARY

A plug connector according to an embodiment of the present disclosure is a plug connector mounted on a board, including: a housing, a plurality of terminals, and a pair of metal fittings, in which the housing has a pair of side wall portions, a pair of coupling wall portions, and a bottom wall portion; the pair of side wall portions protrudes in a fitting direction of fitting in a partner connector, extends in a longitudinal direction of the plug connector, and is provided so as to face each other in a lateral direction of the plug connector; the pair of coupling wall portions protrudes in the fitting direction, extends in the lateral direction, faces each other in the longitudinal direction, and is provided so as to couple both ends of the pair of side wall portions in the longitudinal direction; the bottom wall portion is provided so as to couple, on a bottom side of the housing, the pair of side wall portions and the pair of coupling wall portions; the plurality of terminals is held by each of the pair of side wall portions; the pair of metal fittings is held at both ends of the housing in the longitudinal direction; each of the pair of metal fittings has a pair of mount portions to be mounted on the board, a pair of curved portions, an outer portion, and a pair of coupling portions; the pair of mount portions is provided on the bottom side of the housing so as to face each other in the lateral direction; each of the pair of curved portions is coupled to the mount portion, and is curved so as to stand in the fitting direction from the mount portion along the side wall portion and cover part of an upper surface of the side wall portion; the outer portion is provided so as to cover an upper surface and an outer wall of the coupling wall portion; and each of the pair of coupling portions is provided so as to couple the outer portion to the mount portion and the curved portion.

### BRIEF DESCRIPTION OF THE DRAWINGS

FIG. 1 is a perspective view (view from a fitting side) showing an external configuration of a plug connector according to an embodiment of the present disclosure;

FIG. 2 is an exploded perspective view (view from the fitting side) showing the external configuration of the plug connector according to the embodiment of the present disclosure;

FIGS. 3A and 3B are perspective views (views from the fitting side) showing a partial configuration of the plug connector according to the embodiment of the present disclosure, FIG. 3A showing part of the plug connector and FIG. 3B showing only a metal fitting;

FIGS. 4A and 4B are perspective views (views from the fitting side) showing a partial configuration of the plug connector according to the embodiment of the present disclosure, FIG. 4A showing part of the plug connector and FIG. 4B showing only the metal fitting;

FIGS. 5A and 5B are perspective views (views from a board side) showing a partial configuration of the plug connector according to the embodiment of the present disclosure, FIG. 5A showing part of the plug connector and FIG. 5B showing only the metal fitting;

FIGS. 6A and 6B are perspective views (views from the board side) showing a partial configuration of the plug connector according to the embodiment of the present disclosure, FIG. 6A showing part of the plug connector and FIG. 6B showing only the metal fitting;

FIGS. 7A and 7B are top views showing a partial configuration of the plug connector according to the embodiment of the present disclosure, FIG. 7A showing part of the plug connector and FIG. 7B showing only the metal fitting;

FIGS. 8A and 8B are front views showing a partial configuration of the plug connector according to the embodiment of the present disclosure, FIG. 8A showing part of the plug connector and FIG. 8B showing only the metal fitting; and

FIG. 9 is a perspective view showing the external configurations of the plug connector and a receptacle connector according to the embodiment of the present disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In recent years, components used for electronic devices such as smartphones, portable phones, and portable information terminals have been reduced in size and thickness in response to a demand for reduction in the weight, thickness, and length of these electronic devices. An attempt to reduce a connector to be mounted on a circuit board in size and thickness leads to a problem that it is difficult to maintain strength and durability.

In order to solve the above-described problem, one object of the present disclosure is to reduce a connector in size and improve the strength and durability of the connector.

The features of the present disclosure are apparent from the description of the present specification and the attached drawings.

The summary of the present disclosure is as follows.

The plug connector of the present disclosure is a plug connector mounted on a board, including: a housing, a plurality of terminals, and a pair of metal fittings, in which the housing has a pair of side wall portions, a pair of coupling wall portions, and a bottom wall portion; the pair of side wall portions protrudes in a fitting direction of fitting in a partner connector, extends in a longitudinal direction of the plug connector, and is provided so as to face each other in a lateral direction of the plug connector; the pair of coupling wall portions protrudes in the fitting direction, extends in the lateral direction, faces each other in the longitudinal direction, and is provided so as to couple both ends of the pair of side wall portions in the longitudinal direction; the bottom wall portion is provided so as to couple, on a bottom side of the housing, the pair of side wall portions and the pair of coupling wall portions; the plurality of terminals is held by each of the pair of side wall portions; the pair of metal fittings is held at both ends of the housing in the longitudinal direction; each of the pair of metal fittings has a pair of mount portions to be mounted on the board, a pair of curved portions, an outer portion, and a pair of coupling portions; the pair of mount portions is provided on the bottom side of the housing so as to face each other in the lateral direction; each of the pair of curved portions is coupled to the mount portion, and is curved so as to stand in the fitting direction from the mount portion along the side wall portion and cover part of an upper surface of the side wall portion; the outer portion is provided so as to cover an upper surface and an outer wall of the coupling wall portion; and each of the pair of coupling portions is provided so as to couple the outer portion to the mount portion and the curved portion.

Brief description of effects obtained by a representative embodiment of the present disclosure is as follows.

According to the present disclosure, the strength and durability of the connector can be improved.

Hereinafter, an embodiment of the present disclosure will be described in detail with reference to the drawings. Note that in all the figures for describing the embodiment, the same reference numerals are used to represent the same members in principle and repeated description thereof may be omitted.

The embodiment below will be described as a plurality of divided sections or embodiments as necessary for the sake of convenience, and unless otherwise specified, these sections or embodiments are not independent of each other and one section or embodiment is related to, e.g., part or the entirety of modifications, details, and supplementary explanations of another section or embodiment. Moreover, in a case where, e.g., the number of elements (including, e.g., a quantity, a numerical value, an amount, and a range) is described in the embodiment below, such an element number is not limited to a particular number and may be a particular number or more or a particular number or less, except for, e.g., a specified case and a case where the element number is clearly limited to a particular number in principle.

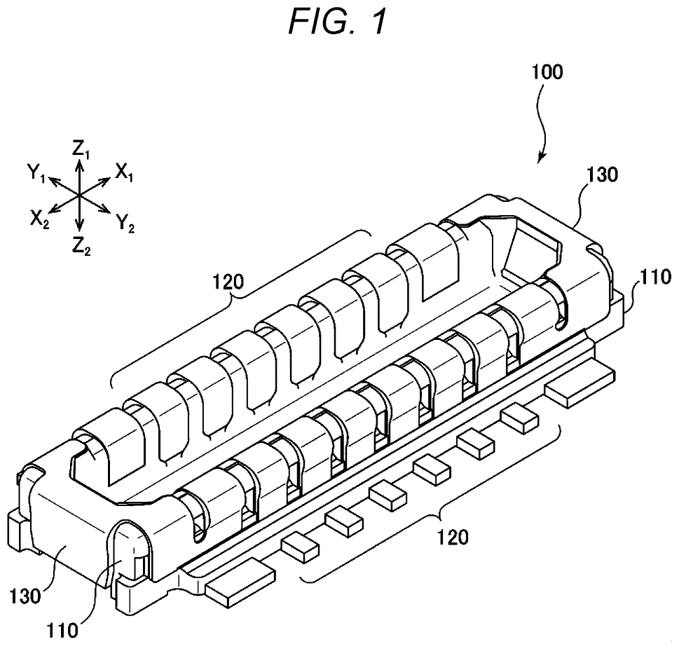

In the description below, the longitudinal direction of a plug connector is an X-direction, the lateral direction thereof is a Y-direction, and the up-down direction thereof is a Z-direction. In FIG. 1 etc., one side and the other side in the X-direction are X₁ and X₂, and one side and the other side in the Y-direction are Y₁ and Y₂, and one side (up direction) and the other side (down direction) in the Z-direction are Z₁ and Z₂. The Z₁-direction is a fitting direction in which the plug connector is fitted in a partner connector, and the Z₂-direction is a direction toward a board. The upper surface side (Z₁-side) of the plug connector may be referred to as a fitting side, and the lower surface side (Z₂-side, bottom side) thereof may be referred to as a board side.

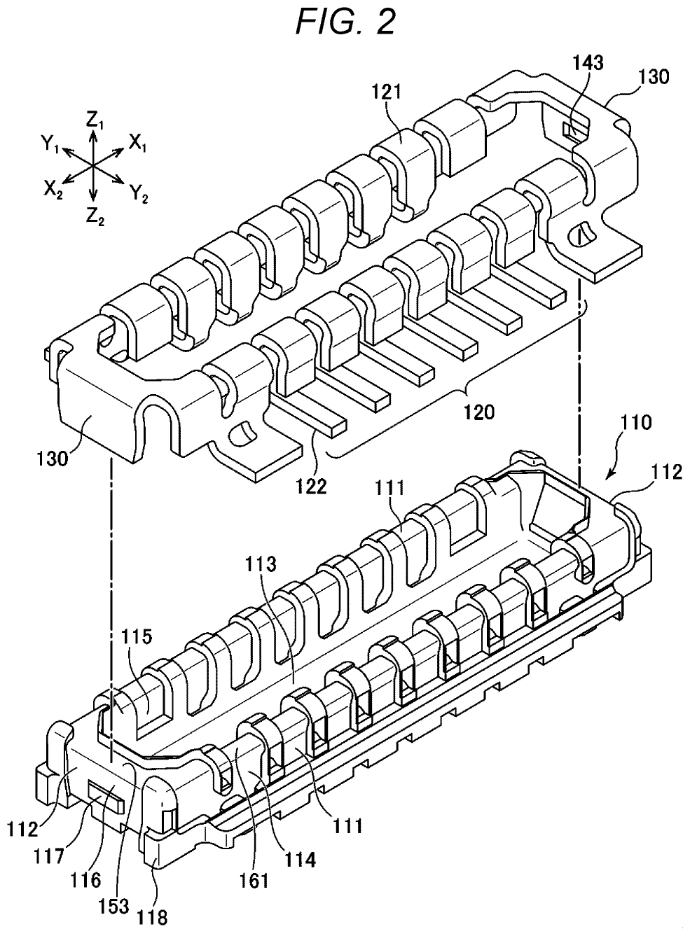

FIG. 1 is a perspective view showing an external configuration of the plug connector according to one embodiment of the present disclosure. FIG. 2 is an exploded perspective view (view from the fitting side) of the plug connector of FIG. 1. A metal portion of, e.g., a terminal and a housing portion are integrally formed by insert molding. Thus, the metal portion of, e.g., the terminal and the housing portion cannot be actually disassembled from each other, but for the sake of easy understanding of the description, FIG. 2 shows these portions disassembled from each other.

First, the configuration of the plug connector according to the embodiment of the present disclosure will be described with reference to FIGS. 1 and 2. The plug connector 100 according to the present embodiment includes an insulating housing 110, a plurality of conductive terminals 120, and a pair of conductive metal fittings 130. The plurality of terminals 120 and the pair of metal fittings 130 are held by the housing 110.

The housing 110 is made of an insulating material such as resin. The terminal 120 and the metal fitting 130 are made of a conductive material such as metal. The plurality of terminals 120 and the pair of metal fittings 130 are formed integrally with the housing 110 by insert molding. In the present embodiment, an example where the number of terminals 120 is 12 is described, but the number of terminals 120 is not limited thereto and may be any number. Note that the terminals 120 are arranged so as to face each other in the lateral direction (Y-direction) of the plug connector 100, and therefore, the number of terminals 120 is preferably an even number. The plurality of terminals 120 has the same shape. The pair of metal fittings 130 has the same shape. The metal fitting 130 can also be used as a power terminal, a ground terminal, or a reinforcing terminal.

The housing 110 includes a pair of side wall portions 111, a pair of coupling wall portions 112, and a bottom wall portion 113. The pair of side wall portions 111 extends in the X-direction, and faces each other in the Y-direction. The pair of coupling wall portions 112 extends in the Y-direction, faces each other in the X-direction, and couples both ends of the pair of side wall portions 111 in the X-direction. The pair of side wall portions 111 and the pair of coupling wall portions 112 protrude in the up direction (Z₁-direction) which is the direction of fitting in the partner connector.

The bottom wall portion 113 forms a bottom portion (Z₂-side portion) of a region surrounded by the pair of side wall portions 111 and the pair of coupling wall portions 112. In other words, the bottom wall portion 113 couples, on the bottom side (lower surface side) of the housing 110, the pair of side wall portions 111 and the pair of coupling wall portions 112 to each other.

The plug connector 100 is formed, for example, by a method in which resin is injected with the terminals 120 and the metal fittings 130 arranged in a mold to form the housing 110, such as integral molding or insert molding.

The plurality of terminals 120 is arranged along each of the pair of side wall portions 111. The plurality of terminals 120 is arranged apart from each other. The terminal 120 includes a contact portion 121 and a mount portion 122. The contact portion 121 has a shape curved so as to protrude in the fitting direction (Z₁-direction). The mount portion 122 extends parallel with the board (not shown) in the Y-direction. Upon fitting in a receptacle connector which is the partner connector, the contact portion 121 contacts a contact portion of the receptacle connector and is electrically connected thereto. The mount portion 122 is soldered to a circuit pattern on the board upon mounting.

The pair of metal fittings 130 is provided so as to face both ends of the plug connector 100 in the X-direction. Specifically, the pair of metal fittings 130 is held so as to face both ends of the housing 110 in the X-direction. The pair of metal fittings 130 is arranged apart from each other so as to face each other in the X-direction outside the plurality of terminals 120 in the X-direction. That is, the plurality of terminals 120 is arranged between the pair of metal fittings 130 in the X-direction. Moreover, the metal fitting 130 is provided so as to be spanned over part of the side wall portions 111 and the coupling wall portion 112. The pair of metal fittings 130 has the same shape. Moreover, each of the pair of metal fittings 130 has a line-symmetric shape with respect to the X-axis.

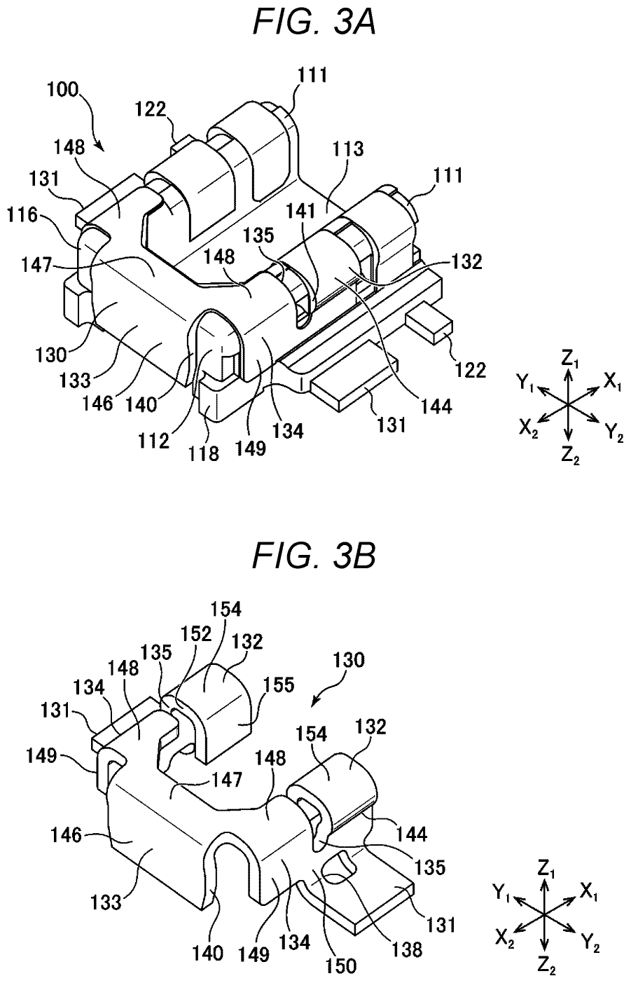

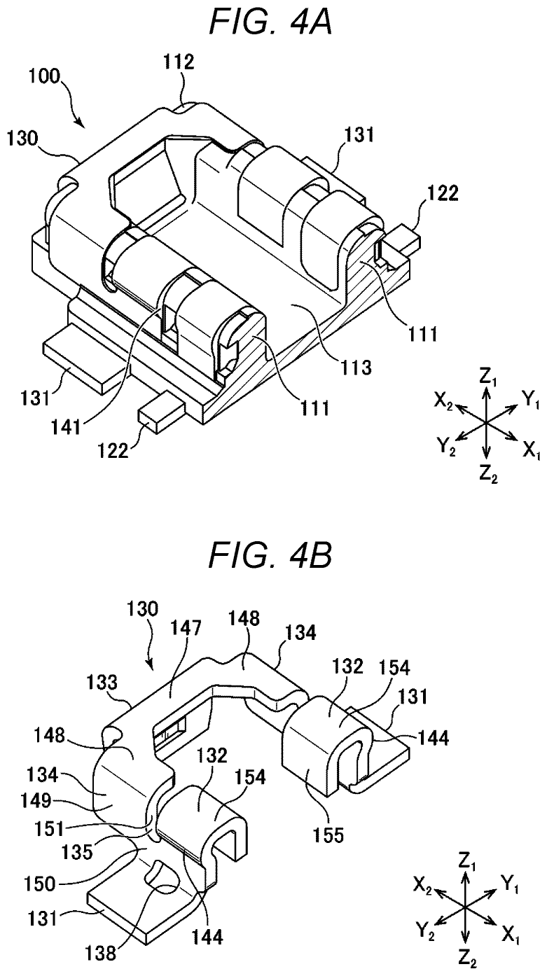

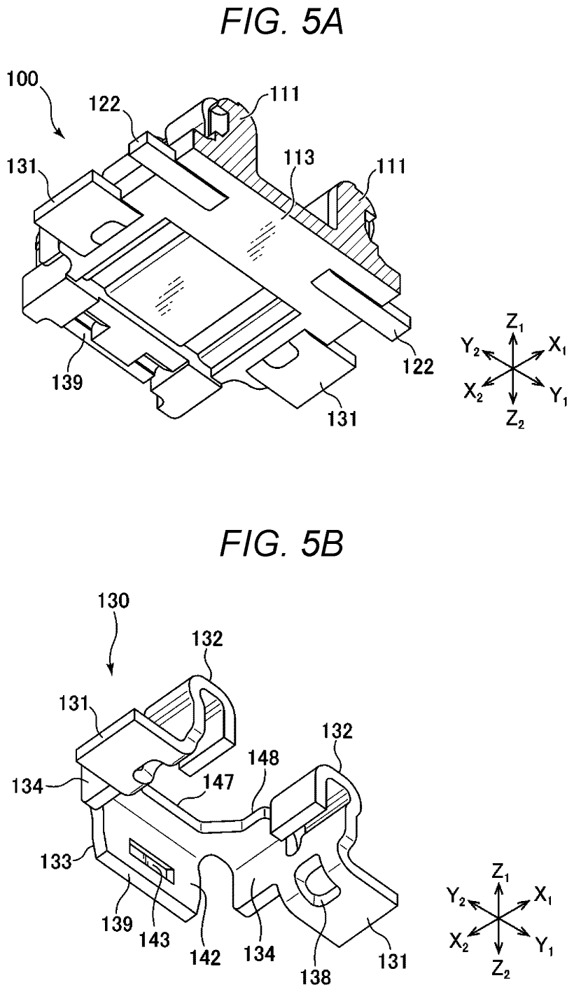

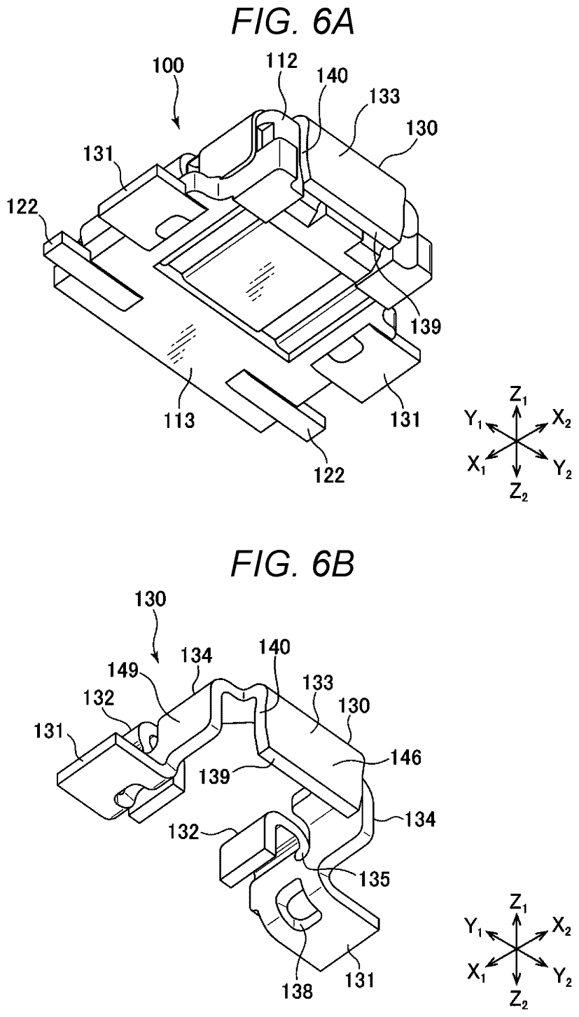

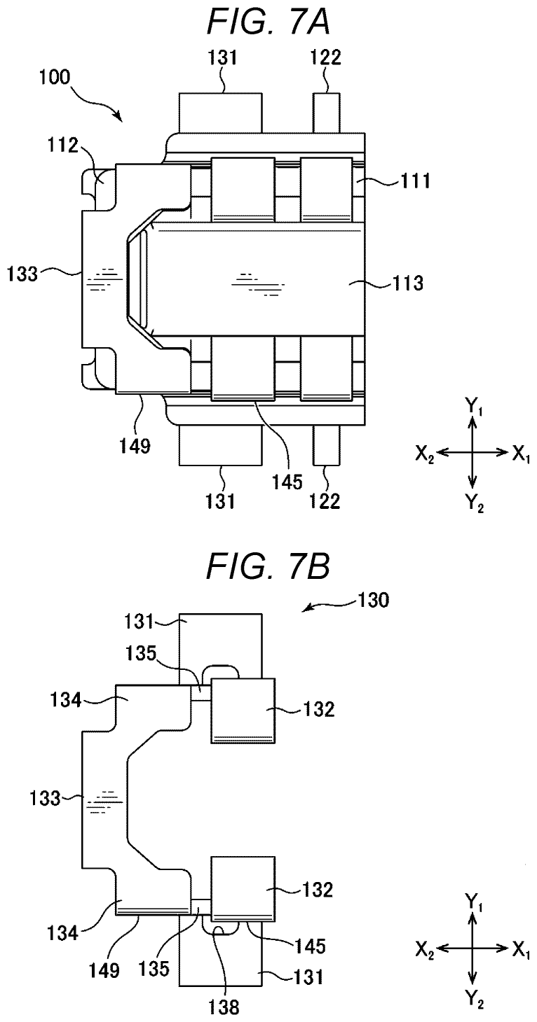

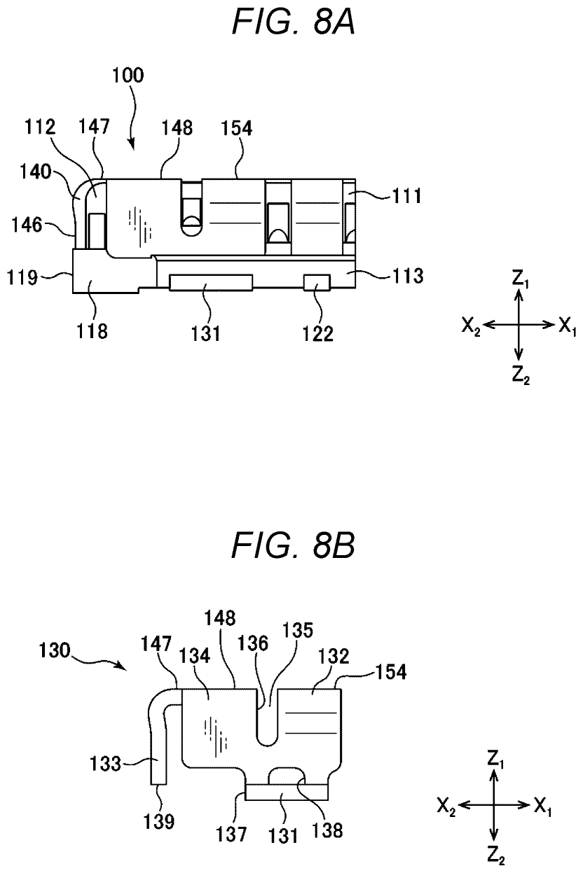

Next, a detailed configuration of the metal fitting 130 will be described with reference to FIGS. 3A to 8B. FIGS. 3A to 6B are perspective views showing a partial configuration of the plug connector 100. Moreover, FIGS. 3A to 4B are perspective views from the fitting side, and FIGS. 5A to 6B are perspective views from the board side. FIGS. 7A and 7B are top views showing a partial configuration of the plug connector 100. FIGS. 8A and 8B are front views showing a partial configuration of the plug connector 100. FIGS. 3A, 4A, 5A, 6A, 7A, and 8A show part of the plug connector 100. FIGS. 3B, 4B, 5B, 6B, 7B, and 8B show only the metal fitting 130.

As shown in FIGS. 2 to 8B, each of the pair of metal fittings 130 has a pair of mount portions 131, a pair of curved portions 132, an outer portion 133, and a pair of coupling portions 134.

The pair of mount portions 131 is provided on the bottom side (lower surface side) of the housing 110 so as to face each other in the Y-direction. The mount portion 131 extends outward in the Y-direction of the plug connector 100 from the side wall portion 111 of the housing 110, and is configured mountable on the board. The lower surface of the mount portion 131 is exposed in the Z₂-direction.

The pair of curved portions 132 is provided so as to face each other in the Y-direction. The curved portion 132 stands in the fitting direction (Z₁-direction) from the mount portion 131 along an outer wall 114 of the side wall portion 111, and is curved along an inner wall 115 of the side wall portion 111 after having extended over the upper surface 161 of the side wall portion 111.

The outer portion 133 extends along the coupling wall portion 112 outside the coupling wall portion 112. Specifically, the outer portion 133 is disposed so as to extend from the upper surface 153 of the coupling wall portion 112 along an outer wall 116 thereof. That is, the outer portion 133 extends so as to cover the upper surface 153 and outer wall 116 of the coupling wall portion 112 (see, e.g., FIG. 2).

The pair of coupling portions 134 is arranged outside the pair of curved portions 132 in the X-direction, and is provided so as to face each other in the Y-direction. The coupling portion 134 couples the outer portion 133 to the mount portion 131 and the curved portion 132. Moreover, the coupling portion 134 is provided so as to cover at least part of the upper surface 161 of the side wall portion 111 and the upper surface 153 of the coupling wall portion 112 between the curved portion 132 and the outer portion 133 (see, e.g., FIG. 2).

A slit 135 is provided between the curved portion 132 and the coupling portion 134.

The outer portion 133 has an outer surface 146 extending in the Z₂-direction and an upper surface 147 connected to the outer surface 146 and extending in the XY plane.

The coupling portion 134 has an upper surface 148 connected to the upper surface 147 of the outer portion 133 and extending in the XY plane and an outer surface 149 standing along the outer wall 114 of the side wall portion 111. A lower portion 150 of the outer surface 149 of the coupling portion 134 is connected to the mount portion 131 and the curved portion 132.

The terminal-120-side (X₁-side) side surface 151 (see FIG. 4B) of the coupling portion 134 forms a side surface 136 of the slit 135. Part of a side surface 152 of the curved portion 132 forming the slit 135 is exposed from the side wall portion 111 (see FIGS. 3A and 3B).

As shown in FIG. 8B, the coupling-portion-134-side side surface 136 of the slit 135 is located on the terminal 120 side (X₁-side) with respect to a side surface 137 on the outer-portion-133-side (X₂-side) of the mount portion 131. With this positional relationship, the strength of the metal fitting 130 can be maintained even in a case where the slit 135 is provided.

As shown in, e.g., FIGS. 3A, 3B, 4A, and 4B, a through-hole 138 is provided among the curved portion 132, coupling portion 134, and mount portion 131 of the metal fitting 130. With the through-hole 138, solder wicking is suppressed upon soldering for mounting, and the metal fittings 130 and the housing 110 are firmly fixed to each other with resin filling the through-hole 138.

As shown in, e.g., FIGS. 3A, 3B, 4A, and 4B, the curved portion 132 of the metal fitting 130 has a raised portion (lock portion) 144 protruding outward (Y-direction), an upper surface 154 covering the upper surface of the side wall portion 111 and located in the fitting direction (Z₁-side), and an inner surface 155 along the inner wall 115. The raised portion (lock portion) 144 is configured to engage with a terminal of the partner connector (receptacle connector) and to be locked to maintain fitting force upon fitting in the partner connector. On the other hand, the coupling portion 134 is provided with no such a raised portion, and has no lock portion. This suppresses the coupling portion 134 of the metal fitting 130 from being scraped. As shown in, e.g., FIGS. 7A and 7B, as viewed from the fitting side (Z₁-side), i.e., in top view, the outer surface 145 of the raised portion 144 of the curved portion 132 is located outside in the Y-direction of the plug connector 100 with respect to the outer surface 149 of the coupling portion 134.

As shown in, e.g., FIGS. 3A, 3B, 4A, and 4B, at least part of both side surfaces 141 of the curved portion 132 of the metal fitting 130 are exposed from the housing 110. Since the end surface or side surface of the metal fitting 130 is exposed, the metal fitting 130 can be held and fixed with the mold when resin is injected in integral molding.

As shown in, e.g., FIGS. 5A, 5B, 6A, and 6B, the board-side (Z₂-side) end portion 139 of the outer portion 133 of the metal fitting 130 has no mount portion to be mounted on the board, and the end surface of the end portion 139 of the outer portion 133 is exposed from the housing 110. Moreover, both side surfaces 140 of the outer portion 133 are also exposed from the housing 110. Note that “exposed from the housing 110” means a state of not being covered with the resin of the housing 110 and not contacting the resin of the housing 110. Since the end surface or side surface of the metal fitting 130 is exposed, the metal fitting 130 can be held and fixed with the mold when resin is injected in integral molding.

As shown in, e.g., FIGS. 5A and 5B, a recessed portion 143 is provided in an inner wall 142 of the outer portion 133 of the metal fitting 130. The recessed portion 143 engages with a raised portion 117 (see FIG. 2) provided on the outer wall 116 of the coupling wall portion 112 of the housing 110, and accordingly, curling of the outer portion 133 of the metal fitting 130 is suppressed.

As shown in, e.g., FIGS. 2, 3A, 3B, 8A, and 8B, the housing 110 includes a projecting portion 118. Specifically, the pair of coupling wall portions 112 of the housing 110 includes a pair of projecting portions 118 outside each corner between the side wall portion 111 and the coupling wall portion 112. As viewed in a direction (Y-direction) parallel with the board and the coupling wall portion 112, an outer surface 119 of the projecting portion 118 is located outside in the X-direction of the plug connector 100 with respect to the outer surface 146 of the outer portion 133 of the metal fitting 130. Since the projecting portions 118 are provided at the bottom-side (Z₂-side) corners of the housing 110 as described above, a mounting device easily grips the projecting portions 118 and moves the plug connector 100 when mounting the plug connector 100 on the board.

As shown in, e.g., FIGS. 8A and 8B, the upper surface 147 of the outer portion 133, the upper surface 148 of the coupling portion 134, and the upper surface 154 of the curved portion 132 are at the same height position in the fitting direction (Z₁-direction). With this configuration, the upper surfaces of the side wall portions 111 and the upper surfaces 153 of the coupling wall portions 112 of the housing 110 are covered with the metal fittings 130, and accordingly, the housing 110 is protected. Further, since the upper surface 147, upper surface 148, and upper surface 154 of the metal fitting 130 are at the same height position, a situation where a receptacle connector 200 (partner connector) concentrically collides with a particular portion of the metal fitting 130 can be avoided, and therefore, deformation and damage of the metal fitting 130 can be suppressed.

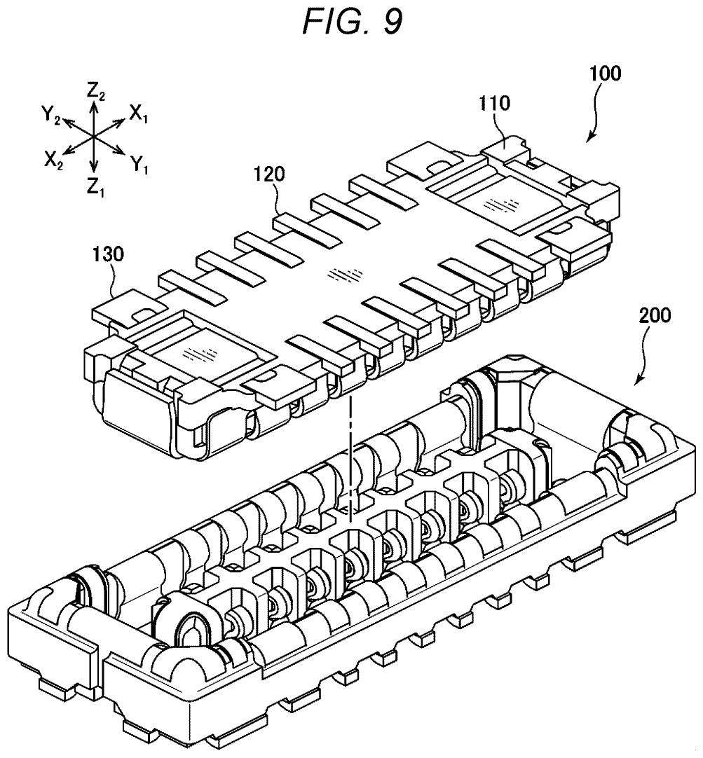

As shown in FIG. 9, a connector assembly according to the embodiment of the present disclosure includes the plug connector 100 and the receptacle connector 200 (partner connector). Each of the plug connector 100 and the receptacle connector 200 is one type of a board-to-board electric connector that electrically connects circuits of printed circuit boards, and is generally mounted on a printed circuit board (not shown) upon use. For example, a rechargeable battery of a portable phone or a portable information terminal and a control circuit thereof are connected to the printed circuit board. The plug connector 100 and the receptacle connector 200 are fitted in each other, and are electrically connected to each other and are electrically connected to the circuits on the printed circuit boards when power terminals and signal terminals thereof contact each other.

Thus, according to the plug connector 100 of the present embodiment, the connector can be reduced in size and the strength and durability thereof can be improved.

The invention made by the present inventor(s) has been specifically described above with reference to the embodiment thereof, but the present disclosure is not limited to the above-described embodiment and various changes can be made without departing from the gist thereof.

For example, in the above-described embodiment, it has been described that the curved portion 132 has the shape standing from the mount portion 131 along the outer wall 114 of the side wall portion 111 and curved along the inner wall 115 of the side wall portion 111 after having extended over the upper surface of the side wall portion 111. Instead, the curved portion 132 may have a shape standing from the mount portion 131 along the inner wall 115 of the side wall portion 111 and curved along the outer wall 114 of the side wall portion 111 after having extended over the upper surface 161 of the side wall portion 111.

The connector according to the present disclosure can be broadly used for, e.g., industrial, business, and domestic purposes.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A plug connector mounted on a board, comprising:
a housing;
a plurality of terminals; and
a pair of metal fittings,
wherein the housing has a pair of side wall portions, a pair of coupling wall portions, and a bottom wall portion,
the pair of side wall portions protrudes in a fitting direction of fitting in a partner connector, extends in a longitudinal direction of the plug connector, and is provided so as to face each other in a lateral direction of the plug connector,
the pair of coupling wall portions protrudes in the fitting direction, extends in the lateral direction, faces each other in the longitudinal direction, and is provided so as to couple both ends of the pair of side wall portions in the longitudinal direction,
the bottom wall portion is provided so as to couple, on a bottom side of the housing, the pair of side wall portions and the pair of coupling wall portions,
the plurality of terminals is held by each of the pair of side wall portions,
the pair of metal fittings is held at both ends of the housing in the longitudinal direction,
each of the pair of metal fittings has a pair of mount portions to be mounted on the board, a pair of curved portions, an outer portion, and a pair of coupling portions,
the pair of mount portions is provided on the bottom side of the housing so as to face each other in the lateral direction,
each of the pair of curved portions is coupled to the mount portion, and is curved so as to stand in the fitting direction from the mount portion along the side wall portion and cover part of an upper surface of the side wall portion,
the outer portion is provided so as to cover an upper surface and an outer wall of the coupling wall portion, and
each of the pair of coupling portions is provided so as to couple the outer portion to the mount portion and the curved portion.

2. The plug connector according to claim 1, wherein
a slit is provided each between the curved portion and the coupling portion.

3. The plug connector according to claim 2, wherein
the plurality of terminals is arranged between the pair of metal fittings in the longitudinal direction, and
a side surface of the slit on a side of the coupling portion is located on a side of the plurality of terminals with respect to a side surface of the outer portion of the mount portion.

4. The plug connector according to claim 1, wherein
each of the pair of metal fittings further has a through-hole, and
the through-hole is provided each among the curved portion, the coupling portion, and the mount portion.

5. The plug connector according to claim 1, wherein
at least part of side surfaces of the curved portions, a side surface of the outer portion, and an end portion of the outer portion on a side opposite to the fitting direction are exposed from the housing.

6. The plug connector according to claim 1, wherein
the outer wall of the coupling portion of the housing has a raised portion, and
an inner wall of the outer portion of the metal fitting has a recessed portion to be engaged with the raised portion.

7. The plug connector according to claim 1, wherein
the curved portion of the metal fitting includes a raised portion,
the raised portion protrudes outward in the lateral direction of the plug connector, and
in a top view, an outer surface of the raised portion is located outside an outer surface of the coupling portion.

8. The plug connector according to claim 1, wherein
each of the pair of coupling wall portions of the housing includes a pair of projecting portions,
each of the pair of projecting portions is provided at a corner between the side wall portion and the coupling wall portion so as to project outward in the longitudinal direction of the plug connector, and
an outer surface of the projecting portion is located outside an outer surface of the outer portion of the metal fitting.

9. A connector assembly comprising:
a plug connector; and
a receptacle connector fittable in the plug connector,
wherein the plug connector includes
a housing, a plurality of terminals, and a pair of metal fittings,
the housing has a pair of side wall portions, a pair of coupling wall portions, and a bottom wall portion,
the pair of side wall portions protrudes in a fitting direction of fitting in the receptacle connector, extends in a longitudinal direction of the plug connector, and is provided so as to face each other in a lateral direction of the plug connector,
the pair of coupling wall portions protrudes in the fitting direction, extends in the lateral direction, faces each other in the longitudinal direction, and is provided so as to couple both ends of the pair of side wall portions in the longitudinal direction,
the bottom wall portion is provided so as to couple, on a bottom side of the housing, the pair of side wall portions and the pair of coupling wall portions,
the plurality of terminals is held by each of the pair of side wall portions,
the pair of metal fittings is held at both ends of the housing in the longitudinal direction,
each of the pair of metal fittings has a pair of mount portions to be mounted on the board, a pair of curved portions, an outer portion, and a pair of coupling portions, the pair of mount portions is provided on the bottom side of the housing so as to face each other in the lateral direction,
each of the pair of curved portions is coupled to the mount portion, and is curved so as to stand in the fitting direction from the mount portion along the side wall portion and cover part of an upper surface of the side wall portion,
the outer portion is provided so as to cover an upper surface and an outer wall of the coupling wall portion, and
each of the pair of coupling portions is provided so as to couple the outer portion to the mount portion and the curved portion.
